(19) United States
(12) Patent Application Publication
(10) Pub. No.: US 2024/0220998 A1
(43) Pub. Date: Jul. 4, 2024

(54) Product Authenticity Validation System

(71) Applicant: Numair Fakir, Brea, CA (US)

(72) Inventor: Numair Fakir, Brea, CA (US)

(21) Appl. No.: 18/092,793

(22) Filed: Jan. 3, 2023

(51) Int. Cl. G06Q 30/018

(52) U.S. Cl. CPC G06Q 30/0185

(57) ABSTRACT

A novel two-step process that involves a sticker containing code pasted on any product and a secondary hidden code that the user can scratch and scan or input to verify the authenticity of a product. If the unique identifiers are not genuine or have been previously conveyed, the consumer is informed that the product may be counterfeit. If the unique identifiers are genuine and have not been previously conveyed, the consumer is informed that the product is authentic and the record is made in the database indicating that the unique identifier has been conveyed.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

Embodiments described herein relate generally to systems and methods for a kind of method for anti-counterfeit of differentiating the authenticity of products.

### Description of the Related Art

Many products bear labels that indicate their nature and origin. Consumers rely on such labeling to ensure that they are purchasing the products they want. However, recent advances in printing and duplicating technologies have made it easy for counterfeiters to produce unauthorized goods that are difficult to distinguish from authenticated goods. The sale of counterfeit goods costs rightful manufacturers and distributors vast amounts of money in lost sales per year. Moreover, these unauthorized goods are often of inferior quality. Thus, their circulation in the marketplace can harm the goodwill and reputation of the true manufacturer. Such difficult-to-quantify, intangible damage can be very difficult to repair or even detect.

non-limiting examples of industries that suffer from counterfeiting are the entertainment, multimedia, pharmaceutical, health and beauty aids, apparel and accessories industries. All of these industries are vulnerable to counterfeiting because of the easily reproducible products that they market, many of which are also associated with a famous style, appearance and/or trademark. Despite the best efforts of manufacturers, counterfeiting continues to thrive.

Another source of “counterfeit” goods can be manufacturers operating under a license or agreement to produce a limited quantity of authorized goods. Such an arrangement can lead to the problem of licensed producers manufacturing excess quantities of the goods, those manufactured in excess of the authorized quantity being considered as unauthorized or counterfeit. The unauthorized products can be indistinguishable from the authorized products, appearing and performing identically thereto. Original equipment manufacturers (OEMs) are, out of necessity, entrusted with the complete specifications and technical assistance to produce the authorized products. Unfortunately, unscrupulous OEMs have been known to use these specifications and know how to produce unauthorized copies of the product in addition to those produced for the authorizing manufacturer. These unauthorized copies can be sold to distributors or retailers at discounts. In addition, some authorized products which have failed a quality control procedure, and are thus unauthorized or “counterfeit”, have been sold to distributors or retailers at discounts. To the consumer, and sometimes even the retailer, the unauthorized copies cannot be distinguished from the authentic products.

The problem of counterfeit goods is not limited to the above-mentioned industries. Other unauthorized items that are commonly pawned off as brand name, authentic goods include clothing, purses, watches, jewelry, other fashion accessories, electronics, such as cellular or portable telephones, radios and personal CD players, CD's, DVD's, CD ROM's, music, “books on tape”, movies, computer software, books, as well as advertised and respected non-durable items, such as pharmaceuticals (both prescription and ‘over-the-counter) and the like.

By looking at prior art multiple processes have been proposed to enhance the process of authenticating a product. Accordingly, a more convenient and effective program is designed which is based on real-time duplicated codes which are scanned by the user to authenticate the product. The present system is applicable to any of these products and others that are vulnerable to counterfeiting (including manufacturing overruns (i.e., quantities in excess of the authorized quantity), rejects from quality control procedures, and even authorized quantities of goods (e.g., clothing) which have not been sold and/or have been returned to the manufacturer.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a system designed to enhance trust and verify the authenticity of products and prevent counterfeiting practices.

The main objective of the invention is to provide an improved real-time interactive code that is printed on the product and another code that is concealed to check the authenticity of the product.

It is further the objective of the invention to provide techniques that enable a user to have access to checking the authenticity of the product and allows the user to gain control which enhances their trust in the brand.

Accordingly, a feature and advantage of the present invention is to provide a system where the user inputs the front code and second code after scratching to check the authenticity of the product.

Another objective of the present invention is to provide an intelligent system that is easy to use and implement.

Thus, is the objective to provide a new and improved method for detecting counterfeit products. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

A novel system allows for verifying the authenticity of goods and for detecting or preventing counterfeiting. The method involves a verification center in communication (direct or indirect) with a database. A verification center is maintained in communication with a database having records corresponding to genuine unique identifiers. The verification center can be located remotely from a point of sale where the consumer purchases the product whose authenticity is to be verified. Such products may be sold in diverse types of stores across a wide geographic area, possibly across the country or even around the world, and including Internet sales

A verification code is printed on the product and another hidden code, which is a unique identifier and contact information for the verification center, is supplied to a consumer in association with the product whose authenticity is to be verified. The consumer enters both codes and these codes are transferred. In response to receipt of the unique identifier, records stored in the database are checked to determine if the unique identifier is genuine and if the unique identifier has been previously conveyed. If the unique identifier is not genuine or has been previously conveyed, the consumer is informed that the product may be counterfeit. If the unique identifier is genuine and has not been previously conveyed, the consumer is informed that the product is authentic and a record is recorded in the database indicating that the unique identifier has been conveyed.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A method of verifying the authenticity of a product, the method comprising:
receiving a verification device in association with a product whose authenticity is to be verified, the verification device having a primary and secondary identifier;
conveying the identifiers to a verification center; and
receiving a response by a recipient informing the recipient whether the product is authentic;
The system as per claim 1, involves a primary code that is printed on the product;
The system as per claim 1, involves a secondary code that is concealed;
The system as per claim 1, wherein the user scratches the secondary code;
The system as per claim 1, wherein the user scans/enters the primary and secondary codes;
The system as per claim 1, wherein the codes are matched with the backend-maintained database; and,
The system, as per claim 1, wherein the user is informed of the status of the product.
